(19) United States
(12) Patent Application Publication
(10) Pub. No.: US 2021/0188432 A1
(43) Pub. Date: Jun. 24, 2021

(54) Drone Operated Umbrella

(71) Applicant: Hassan Yagoub, LAFAYETTE, LA (US)

(72) Inventor: Hassan Yagoub, LAFAYETTE, LA (US)

(21) Appl. No.: 17/104,130

(22) Filed: Nov. 25, 2020

Related U.S. Application Data
(60) Provisional application No. 62/952,760, filed on Dec. 23, 2019.

(51) Int. Cl. B64C 39/02; A45B 25/20

(52) U.S. Cl. CPC B64C 39/024; A45B 25/20; B64C 2201/027; A45B 2200/1009; B64C 2201/108; B64C 2201/12; B64C 2201/145; B64C 2201/042

(57) ABSTRACT

A drone operated umbrella is shown and described. The drone operated umbrella includes a waterproof canopy secured to a framing. The framing is secured to a drone housing. The drone housing has a plurality of arms which extend through the waterproof canopy. Each of the plurality of arms has a propeller rotatably attached to an end of the arm. The drone is comprised of at least one power source. The at least one power source is coupled to at least one motor. The power source is further coupled to a wireless transceiver.

### CROSS REFERENCE TO RELATED APPLICATIONS

This application claims the benefit of U.S. Provisional Application No. 62/952,760 filed on Dec. 23, 2019. The above identified patent application is herein incorporated by reference in its entirety to provide continuity of disclosure.

### BACKGROUND OF THE INVENTION

The present invention relates to hands-free umbrellas. More particularly, the present invention provides a device that will fly an umbrella over a user.

There are many different forms of protecting an individual from weather. When there is precipitation in the forecast some individuals use a coat. Others choose to use an umbrella. Umbrellas may also be used to protect individuals from exposure to the sun.

Traditional umbrellas have a waterproof canopy attached to a skeleton. The skeleton is then attached to a rod having a handle at one end. While an umbrella may be extremely useful, having to hold the handle is a draw back. This means that an individual only has one hand to conduct activities with. If a user needs to hold an item, for example, a traditional umbrella may be difficult to handle.

Consequently, there is a need for an improvement in the art of rain protection. The present invention substantially diverges in design elements from the known art while at the same time solves a problem many people face when needing protection from the elements but also not having the hands to hold an umbrella. In this regard the present invention substantially fulfills these needs.

### SUMMARY OF THE INVENTION

The present invention provides a drone operated umbrella wherein the same can be utilized for providing convenience for the user when using a hands free umbrella. The drone operated umbrella is comprised of a waterproof canopy secured to a framing. The framing is secured to a drone housing. The drone housing has a plurality of arms which extend through the waterproof canopy. Each of the plurality of arms has a propeller rotatably attached to the end of the arm. The drone is comprised of at least one power source. The at least one power source is coupled to at least one motor. The power source is further coupled to a wireless transceiver.

Another object of the drone operated umbrella is to have a clear canopy.

Another object of the drone operated umbrella is to have framing which is collapsible.

Another object of the drone operated umbrella is to have the wireless transceiver connected to a locational beacon.

Another object of the drone operated umbrella is to have the drone is configured to fly using artificial intelligence.

Another object of the drone operated umbrella is to have the drone will fly over the beacon.

Another object of the drone operated umbrella is to have the wireless transceiver connected to a mobile device.

Another object of the drone operated umbrella is to have the mobile device runs a mobile application.

Another object of the drone operated umbrella is to have the mobile application will summon the drone to the mobile devices location.

Another object of the drone operated umbrella is to have the mobile application will chart a path for the drone.

Another object of the drone operated umbrella is to have the mobile application has a height selector that will tell the drone how high to fly.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the drone operated umbrella.

FIG. 2 shows a cross-sectional view of an embodiment the drone operated umbrella.

FIG. 3A shows a top down view of an embodiment of the drone for the drone operated umbrella.

FIG. 3B shows a perspective view of an embodiment of the umbrella skeleton.

FIG. 4 shows a wiring diagram for an embodiment of the drone operated umbrella.

FIG. 5 shows an alternative wiring diagram for an embodiment of the drone operated umbrella.

FIG. 6 shows a top down view of an embodiment of a mobile application for the drone operated umbrella.

### LIST OF REFERENCE NUMERALS

With regard to the reference numerals used, the following numbering is used throughout the drawings.
101 Canopy
102 Apex
103 Drone arms
103a Telescopic section
103b Telescopic section
103c Telescopic section
104 Propeller
105 Waterproof seal
201 First material
202 Second material
203 Skeleton
203a Center pole
203b Skeleton arms
204 Drone housing
205 Motion sensor
206 Plurality of motion sensors
601 hinge connection
301 Power source
302 Motor
303 CPU
304 Wireless transceiver
305 Beacon
401 Mobile device
402 wireless transceiver
403 CPU
501 Select height
502 Chart course
503 Follow phone
504 request drone
505 Manual control

### DETAILED DESCRIPTION OF THE INVENTION

Reference is made herein to the attached drawings. Like reference numerals are used throughout the drawings to depict like or similar elements of the drone operated umbrella. For the purposes of presenting a brief and clear description of the present invention, a preferred embodiment will be discussed as used for the drone operated umbrella. The figures are intended for representative purposes only and should not be considered to be limiting in any respect.

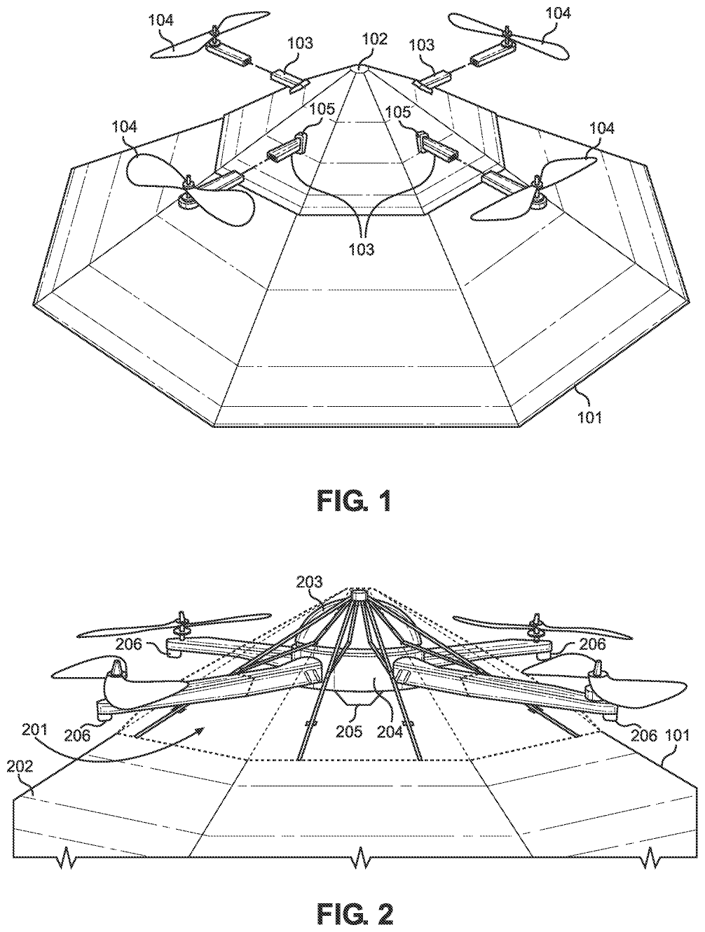

Referring now to FIG. 1, there is shown a perspective view of an embodiment of the drone operated umbrella. The drone operated umbrella includes a canopy 101. The canopy 101 is comprised of at least a first material. The first material is a waterproof material. The canopy 101 is sized to extend past the shoulders of a human being. In one embodiment the canopy 101 forms an apex 102 at the top of the canopy 101. The apex 102 will be the highest point of the umbrella all other parts will slope away from the apex 102. This will ensure that no liquids are trapped within the canopy 101.

The canopy 101 has a plurality of drone arms 103 protruding therethrough. In one embodiment the drone arms 103 protrude through apertures located in the canopy 101. In one embodiment the apertures in the canopy 101 have water proof seals 105 located around the drone arms 103. This will prevent liquid from leaking around the drone arms and onto the individual using the device. In another embodiment the canopy is configured to cover the drone arms 103. The drone arms 103 will attached to a drone body as described in the description of FIG. 2.

Each of the plurality of drone arms 103 are rotatably coupled to at least one propeller 104. The propellers 104 are sized to spin and create lift to the drone controlled umbrella. The propellers 104 are further sized and positioned to rotate without contacting the canopy 101. In the shown embodiment there are four drone arms 103, and four propellers 104. The shown number is not meant to be limiting to the number of drone arms 103 or propellers 104 in any way and varying number of drone arms 103 and propellers 104 may be used.

In one embodiment the drone arms 103 are separable. This means that the drone arms 103 will have the ability to have the section where the propellers 104 are attached to be separated from the drone. In one embodiment the drone arms 103 will secure together via a friction fit. In another embodiment there are fasteners that will secure the drone arms 103 together.

Referring now to FIG. 2, there is shown a cross-sectional view of an embodiment the drone operated umbrella. The shown embodiment the canopy 101 is made from a first material 201 and a second material 202. The first material 201 is a dark colored waterproof material. The second material 202 is a clear waterproof material. This will allow the canopy 101 to lower around a user's head still allowing the user to see through the canopy 101. In other embodiments different combinations of canopy materials may be used.

The is a skeleton 203 that is secured to the underside of the canopy 101. The skeleton 203 is comprised of a plurality of light weight rods. The light weight rods are coupled together to support the canopy 101 in an open position. In one embodiment the plurality of light weight rods are coupled together such that the skeleton 203 is collapsible. This will allow the canopy 101 to be collapsed for better storage.

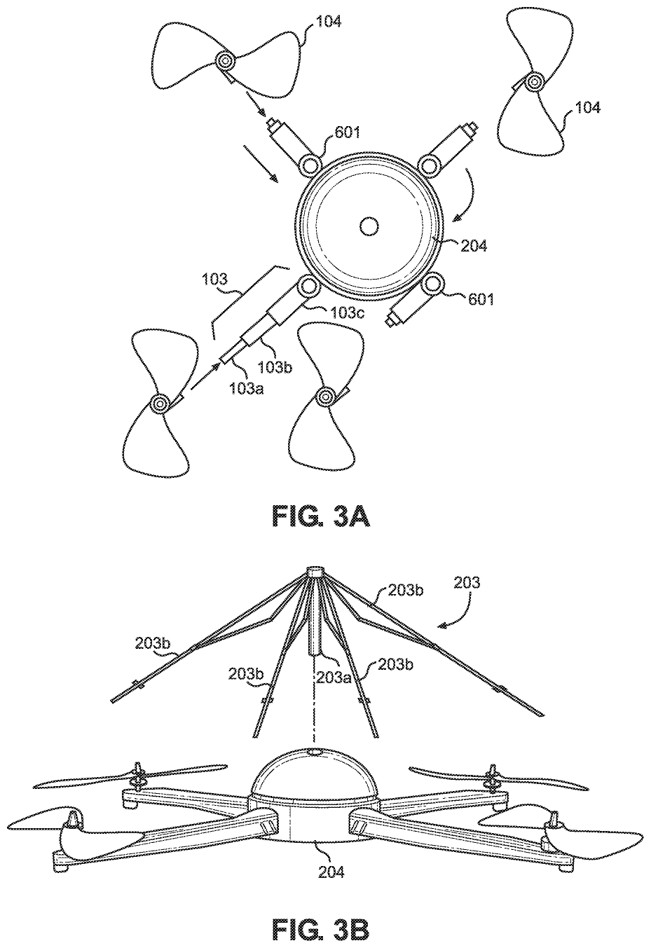

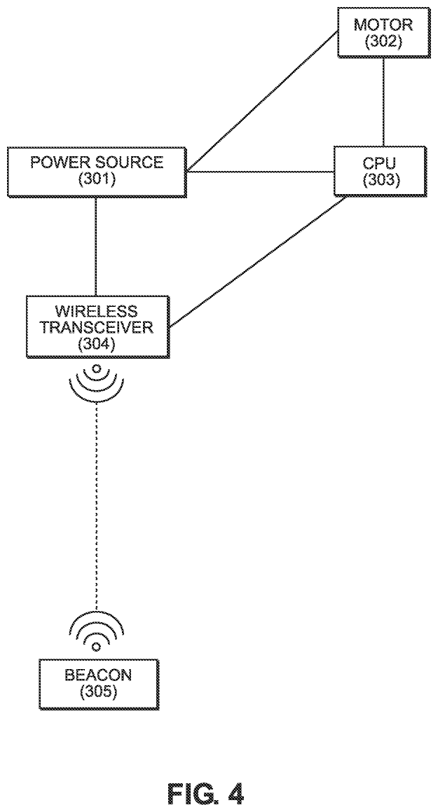

The drone arms 103 are secured to a drown housing 204. The drone housing 204. The drone housing 204 will hold the operational components of the drone as described in the description of FIG. 3 and FIG. 4. The drone housing 204 is secured to the underside of the skeleton 203. This will hold the skeleton 203 above the drone housing 204.

In one embodiment there are a plurality of motions sensors 206 located at the end of each drone arm 103. The motions sensors will help the drone to fly directly over an individual or at a certain height. In another embodiment there is a motion sensor 205 secured to a bottom of the drone housing. This sensor will help enable the drone to fly over an individual and remain centered over the individual.

Referring now to FIG. 3A, there is shown a top down view of an embodiment of the drone for the drone operated umbrella. In one embodiment the done arms 103 are collapsible for storage. In one embodiment an end of the drone arms 103 attached to the propeller 104 is removed as described above. The drone arms 103 may then be bent toward the drone housing 204 via a hinge connection 601 of each arm. In one embodiment the propeller 104 is then secured to the drone housing 204 for storage.

In one embodiment the drone arms 103 have telescopic sections 103a, 103b, 103c. Each of the telescopic sections 103a, 103b, 103c will fit within the next section. This will allow the drone arms 103 to further collapse into an even smaller size for storage. In on embodiment the arms 103 are locked into the extended position. In another embodiment the drone arms 103 are held in the extended position via a friction fit.

Referring now to FIG. 3B, there is shown a perspective view of an embodiment of the umbrella skeleton. In one embodiment the skeleton 203 is separable form the drone housing 204. In another embodiment the skeleton is collapsible. In this embodiment the skeleton will function much like that of a traditional umbrella. The skeleton 203 will include a center post 203a which has a slider and will pull arms 203b of the skeleton toward the center post as it is lowered. This will allow the umbrella portion to be removed and collapsed for storage.

Referring now to FIG. 4, there is shown a wiring diagram for an embodiment of the drone operated umbrella. The drone housing will hold at least the following components, other components may also be housed within the drone housing. The drone housing holds a power source 301. In one embodiment the power source 301 is a battery. The power source 301 is electrically coupled to at least one motor 302. The at least one motor 302 will rotate and control the plurality of propellers, thus controlling the drone.

The power source 301 and the at least one motor 302 will further be electrically coupled to a CPU 303. The CPU 303 will control the at least one motor 302 to control the drone. The CPU 303 and the power source 301 are electrically coupled to a wireless transceiver 304. The wireless transceiver 304 will receive instructions to deliver to the CPU 303 to control the drone. In some embodiments the CPU 303 will be able to use an artificial intelligence to control the drone.

In one embodiment the wireless transceiver 304 is wirelessly coupled to a beacon 305. The beacon 305 will transmit the position of the beacon 305. This will allow the CPU 303 to direct the drone over that position. Further, in one embodiment, the beacon 305 will transmit the height above sea level of the beacon 305. This will allow the CPU 303 to direct the drone at a proper height over the beacon 305.

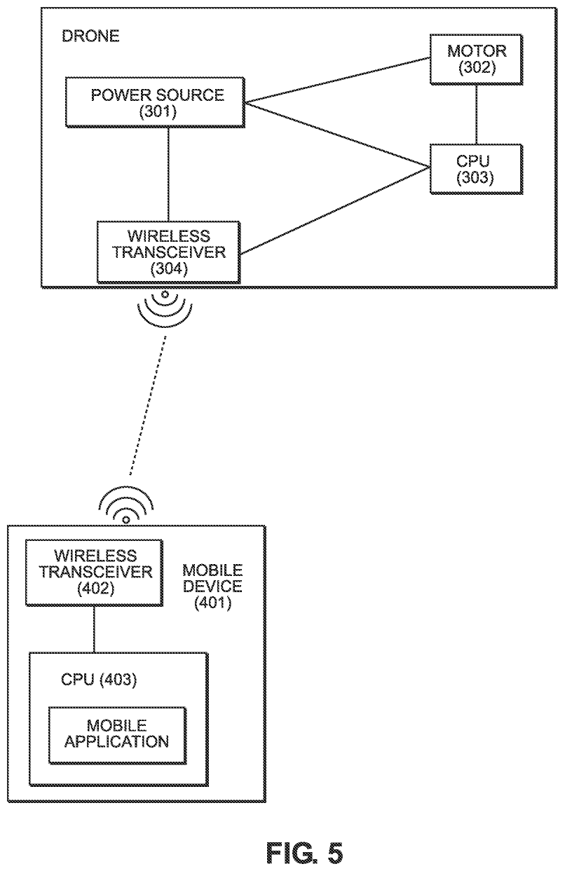

Referring now to FIG. 5, there is shown an alternative wiring diagram for an embodiment of the drone operated umbrella. The drone housing holds a power source 301. In one embodiment the power source 301 is a battery. The power source 301 is electrically coupled to at least one motor 302. The at least one motor 302 will rotate and control the plurality of propellers, thus controlling the drone.

The power source 301 and the at least one motor 302 will further be electrically coupled to a CPU 303. The CPU 303 will control the at least one motor 302 to control the drone. The CPU 303 and the power source 301 are electrically coupled to a wireless transceiver 304. The wireless transceiver 304 will receive instructions to deliver to the CPU 303 to control the drone.

In one embodiment the wireless transceiver 304 is wirelessly coupled to a mobile device 401. The mobile device includes a wireless transceiver 402 operably coupled to a CPU 403. While not necessarily and electrical connection the CPU 403 will run a mobile application to give direction to the drone. In one embodiment the mobile device 401 will control the drone similar to the beacon. In other embodiments as described in the description of FIG. 5 the mobile device 401 will control the drone in other manners.

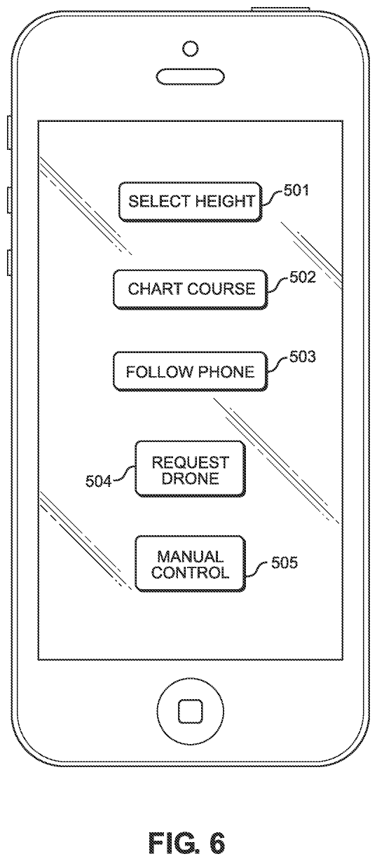

Referring now to FIG. 6, there is shown a top down view of an embodiment of a mobile application for the drone operated umbrella. In different embodiments the mobile application to operate the drone operated umbrella will include different combinations of elements. The elements described and shown are to be exemplary of many of the drone features. The mobile application is further shown as an example of a home screen other screens, GUIs, and images may be used.

In one embodiment the mobile application has the ability to select the height for which the drone is to fly 501. In one embodiment this selection allows for selection of the height above sea level. In another embodiment the selection allows for the height of the drone from the mobile device. These options will help to ensure that a user can select the desired height.

In one embodiment the mobile application has a chart course option 502. The chart course option 502 allows a user to chart a course for the drone to fly. In one embodiment the course is shown on a map. In another embodiment the user can select how fast the drone should fly along the course. In yet another embodiment the chart course option gives the drone a general course then the course will be made specific to the location of the mobile device.

In yet another embodiment the mobile application has a follow phone option 503. In this option the phone will operate as the beacon described in FIG. 3. In one embodiment this option further allows a user to set following parameters. In one embodiment the parameter includes the height of the drone and the distance at which the drone should follow the mobile device.

In other embodiments the mobile application has a request drone option 504. This option will allow for the drone to be summoned to the device location. In another embodiment the request drone option 504 will allow for the drone to be summoned to a chosen location.

In a further embodiment the mobile application will allow for manual control of the drone 505. In one embodiment when this option is selected the phone will operate as a drone controller. In another embodiment a separate controller will be needed to control the drone when the manual control option is selected.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A drone operated umbrella, comprising:
a waterproof canopy secured to a skeleton;
the skeleton secured to a drone housing;
the drone housing further comprising a plurality of arms; wherein each of the plurality of arms extend through the waterproof canopy;
each of the plurality of arms further comprising a propeller rotatably attached to the end of the arm.

2) The drone operated umbrella of claim 1, wherein the canopy is clear.

3) The drone operated umbrella of claim 1, wherein the skeleton is collapsible.

4) The drone operated umbrella of claim 1, further comprising a wireless transceiver.

5) The drone operated umbrella of claim 4, wherein the wireless transceiver is connected to a locational beacon.

6) The drone operated umbrella of claim 1, wherein the drone is configured to fly using artificial intelligence.

7) The drone operated umbrella of claim 5, wherein the drone will fly over the beacon.

8) A drone operated umbrella, comprising:
a waterproof canopy secured to a skeleton;
the skeleton is secured to a drone housing;
the drone housing has a plurality of arms which extend through the waterproof canopy;
each of the plurality of arms has a propeller rotatably attached to the end of the arm;
the drone further comprising at least one power source;
the at least one power source coupled to at least one motor;
the at least one power source further coupled to a wireless transceiver.

9) The drone operated umbrella of claim 1, wherein the canopy is clear.

10) The drone operated umbrella of claim 1, wherein the skeleton is collapsible.

11) The drone operated umbrella of claim 4, wherein the wireless transceiver is connected to a locational beacon.

12) The drone operated umbrella of claim 1, wherein the drone is configured to fly using artificial intelligence.

13) The drone operated umbrella of claim 5, wherein the drone will fly over the beacon.

14) The drone operated umbrella of claim 8, wherein the wireless transceiver is connected to a mobile device.

15) The drone operated umbrella of claim 14, wherein the mobile device runs a mobile application;
the mobile application will summon the drone to the mobile device's location.

16) The drone operated umbrella of claim 14, wherein the mobile device runs a mobile application;
the mobile application will chart a path for the drone.

17) The drone operated umbrella of claim 14, wherein the mobile device runs a mobile application;
the mobile application has a height selector that will tell the drone how high to fly.
